(19) United States
(12) Patent Application Publication
(10) Pub. No.: US 2026/0031647 A1
(43) Pub. Date: Jan. 29, 2026

(54) ADAPTIVE CHARGING THERMAL OPTIMIZATION SYSTEMS AND METHODS FOR ELECTRIFIED VEHICLES

(71) Applicant: FCA US LLC, Auburn Hills, MI (US)

(72) Inventors: Mateo Restrepo, Auburn Hills, MI (US); Katherine Morrow-Abraham, Auburn Hills, MI (US); Mark Casamer, Auburn Hills, MI (US); Ali Abdulsaid, Auburn Hills, MI (US); Jason E Wielenga, Auburn Hills, MI (US)

(21) Appl. No.: 18/784,239

(22) Filed: Jul. 25, 2024

(51) Int. Cl. H02J 7/00; B60L 53/14; B60L 58/24; H01M 10/44

(52) U.S. Cl. CPC H02J 7/007194; B60L 53/14; B60L 58/24; H01M 10/443; H02J 7/0048; H02J 7/005; H02J 7/00714; H02J 7/007182

(57) ABSTRACT

An adaptive charging thermal optimization system for an electrified vehicle includes a set of thermal management components each configured to thermally condition a high voltage battery system of the electrified vehicle and a control system configured to detect whether the electrified vehicle is plugged into electrified vehicle supply equipment (EVSE) and, in response to detecting that the electrified vehicle is plugged into the EVSE, determine a set of charging parameters and limits for the high voltage battery system and the EVSE, determine a type or mode of the EVSE, determine a temperature setpoint for the high voltage battery system based on the charging parameters and limits for the high voltage battery system and the EVSE and the type or mode of the EVSE, and control the set of thermal management components based on the determined temperature setpoint and a measured temperature of the high voltage battery system.

### FIELD

The present application generally relates to electrified vehicles and, more particularly, to adaptive charging thermal optimization systems and methods for electrified vehicles.

### BACKGROUND

Some electrified vehicles are configured for plug-in charging of a high voltage battery pack or system via electrified vehicle supply equipment (EVSE), which typically includes a charging port/cable and an external charging station. In the United States, conventional plug-in charging is divided into three different modes: (1) level one alternating current (AC) charging, (2) level two (higher power) AC charging, and (3) direct current (DC) fast charging, or “DCFC.” A thermal management system is configured to maintain a temperature of the battery system within a desired range. The charge accepted by the battery system, however, is a function of this temperature and voltage. Conventional thermal management techniques utilize a single fixed (static) heating/cooling profile for all or for each of the different charging modes. This can result in longer/inefficient charging due to EVSE power limits. Accordingly, while such conventional charging and thermal management systems do work for their intended purpose, there exists an opportunity for improvement in the relevant art.

### SUMMARY

According to one example aspect of the invention, an adaptive charging thermal optimization system for an electrified vehicle is presented. In one exemplary implementation, the adaptive charging thermal optimization system comprises a set of thermal management components each configured to thermally condition a high voltage battery system of the electrified vehicle and a control system configured to detect whether the electrified vehicle is plugged into electrified vehicle supply equipment (EVSE) and, in response to detecting that the electrified vehicle is plugged into the EVSE: determine a set of charging parameters and limits for the high voltage battery system and the EVSE, determine a type or mode of the EVSE, determine a temperature setpoint for the high voltage battery system based on the charging parameters and limits for the high voltage battery system and the EVSE and the type or mode of the EVSE, and control the set of thermal management components based on the determined temperature setpoint and a measured temperature of the high voltage battery system.

In some implementations, the control system is configured to dynamically determine the temperature setpoint for the high voltage battery system. In some implementations, the determined temperature setpoint is not a predefined or predetermined temperature setpoint corresponding to the type or mode of the EVSE. In some implementations, the control system is further configured to: determine a first temperature setpoint for the high voltage battery system based on a health or life target for the high voltage battery system, determine a second temperature setpoint for the high voltage battery system based on temperature and input current to the high voltage battery system, and select a lesser of the first and second temperature setpoints as the determined temperature setpoint for the high voltage battery system.

In some implementations, the set of charging parameters and limits for the high voltage battery system and the EVSE include at least one of (i) battery maximum temperature, (ii) battery minimum temperature, (iii) ambient temperature, (iv) EVSE maximum current, (v) control system arbitrated current, and (vi) battery maximum allowable current. In some implementations, the set of charging parameters and limits for the high voltage battery system and the EVSE include (i) battery maximum temperature, (ii) battery minimum temperature, (iii) ambient temperature, (iv) EVSE maximum current, (v) control system arbitrated current, and (vi) battery maximum allowable current.

In some implementations, the set of charging parameters and limits further includes at least one of (i) available input current, (ii) available DC current, (iii) driver power level selection, (iv) battery cell voltage, and (v) battery state of charge (SOC). In some implementations, the set of charging parameters and limits further includes (i) available input current, (ii) available DC current, (iii) driver power level selection, (iv) battery cell voltage, and (v) battery SOC.

In some implementations, the type or mode of the EVSE is defined by the Society of Automotive Engineers (SAE) J1772 Standard and is one of (i) AC level one charging, (ii) AC level two charging, and (iii) DC charging. In some implementations, the type or mode of the EVSE is defined by the International Electrotechnical Commission (IEC) 61851-1 Standard and is one of (i) Mode 2 charging, (ii) Mode 3 charging, and (iii) Mode 4 charging.

According to another example aspect of the invention, an adaptive charging thermal optimization method for an electrified vehicle is presented. In one exemplary implementation, the adaptive charging thermal optimization method comprises detecting, by a control system of the electrified vehicle, whether the electrified vehicle is plugged into EVSE and, in response to detecting that the electrified vehicle is plugged into the EVSE: determining, by the control system, a set of charging parameters and limits for the high voltage battery system and the EVSE, determining, by the control system, a type or mode of the EVSE, determining, by the control system, a temperature setpoint for the high voltage battery system based on the charging parameters and limits for the high voltage battery system and the EVSE and the type or mode of the EVSE, and, based on the determined temperature setpoint and a measured temperature of the high voltage battery system, controlling, by the control system, a set of thermal management components each configured to thermally condition a high voltage battery system of the electrified vehicle.

In some implementations, the determining of the temperature setpoint is performed dynamically based on based on the charging parameters and limits for the high voltage battery system and the EVSE and the type or mode of the EVSE. In some implementations, the determined temperature setpoint is not a predefined or predetermined temperature setpoint corresponding to the type or mode of the EVSE. In some implementations, the adaptive charging thermal optimization method further comprises: determining, by the control system, a first temperature setpoint for the high voltage battery system based on a health or life target for the high voltage battery system, determining, by the control system, a second temperature setpoint for the high voltage battery system based on temperature and input current to the high voltage battery system, and selecting, by the control system, a lesser of the first and second temperature setpoints as the determined temperature setpoint for the high voltage battery system.

In some implementations, the set of charging parameters and limits for the high voltage battery system and the EVSE include at least one of (i) battery maximum temperature, (ii) battery minimum temperature, (iii) ambient temperature, (iv) EVSE maximum current, (v) control system arbitrated current, and (vi) battery maximum allowable current. In some implementations, the set of charging parameters and limits for the high voltage battery system and the EVSE include (i) battery maximum temperature, (ii) battery minimum temperature, (iii) ambient temperature, (iv) EVSE maximum current, (v) control system arbitrated current, and (vi) battery maximum allowable current.

In some implementations, the set of charging parameters and limits further includes at least one of (i) available input current, (ii) available DC current, (iii) driver power level selection, (iv) battery cell voltage, and (v) battery SOC. In some implementations, the set of charging parameters and limits further includes (i) available input current, (ii) available DC current, (iii) driver power level selection, (iv) battery cell voltage, and (v) battery SOC.

In some implementations, the type or mode of the EVSE is defined by the Society of Automotive Engineers (SAE) J1772 Standard and is one of (i) AC level one charging, (ii) AC level two charging, and (iii) DC charging. In some implementations, the type or mode of the EVSE is defined by the International Electrotechnical Commission (IEC) 61851-1 Standard and is one of (i) Mode 2 charging, (ii) Mode 3 charging, and (iii) Mode 4 charging.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example adaptive charging thermal optimization system according to the principles of the present application;

FIG. 2 is a functional block diagram of an example system architecture for the adaptive charging thermal optimization system according to the principles of the present application; and

FIG. 3 is a flow diagram of an example adaptive charging thermal optimization method for an electrified vehicle according to the principles of the present application.

### DESCRIPTION

As previously discussed, some electrified vehicles (battery electric vehicles, or BEVs, plug-in hybrid electric vehicles, or PHEVs, etc.) are configured for plug-in charging via electrified vehicle supply equipment (EVSE), such as a charging port, a charging plug/cable, and an external charging station (e.g., connected to a separate alternating current (AC) power source). In North America, conventional charging of electrified vehicles (e.g., as defined by the Society of Automotive Engineers (SAE) J1772 Standard) is divided into three different modes: (1) level one AC charging (e.g., 1.0-1.4 KW), (2) level two AC charging (e.g., up to 19.2kW), and (3) direct current (DC) fast charging, or “DCFC” (e.g., 25-350 KW). The charge accepted by a high voltage battery system is a function of this temperature and voltage. Thus, a thermal management system is also provided and configured to maintain a temperature of the battery system within a desired range (e.g., for optimal charging performance). Conventional thermal management techniques utilize a single fixed (static) heating/cooling profile for all of or for each of the different charging modes. This can result in longer/inefficient charging due to EVSE power limits. In most cases, the EVSE is power-limited due to its temperature (e.g., extreme cold or heat).

For example only, in an electrified vehicle capable of 150 KW charging using EVSE with a 50 kilowatt (KW) power limit, the battery system would be conditioned for 150 KW even though the max is 50 KW, thereby resulting in wasted energy due to the thermal conditioning prioritization over charging power/current. More specifically, the thermal management system conditions the battery system to a temperature with the intention of reaching maximized current at full power, but because the EVSE cannot provide that power this is wasted energy, and the thermal management system could have stopped conditioning at an earlier temperature and used more power/current for charging the battery system. This could potentially result in decreased component life and increased warranty costs due to excessive thermal conditioning (wear on thermal components, wear on the battery system and thereby a reduced battery system state of health (SOH), etc.). There is also a potential inability for proper thermal conditioning of the battery system due to the limited available power, thereby resulting in less efficient charging and increased charging costs.

Accordingly, adaptive charging thermal optimization systems and methods for plug-in chargeable electrified vehicles (BEVs, PHEVs, etc.) are presented herein. These techniques determine dynamic temperature targets for the battery system during plug-in charging. The dynamic temperature targets are determined based on, for example, available charge power/current, minimum/maximum temperatures for the battery system, ambient temperature, and the like. These dynamic temperature targets are then used to control the thermal management system (e.g., via respective dynamic coolant flow targets). More specifically, the thermal management system can target a temperature to condition the battery system so that the electrified vehicle will not waste time or energy and reduce unnecessary thermal system use and extend component life. The thermal system management system will be able to optimize its performance by optimizing battery system conditioning rates through monitoring of the current available and adjusting its temperature target. The thermal management system can then stop conditioning the battery system when the calculated thermal limit matches the calculated battery temperature threshold or battery system life targets. Potential benefits include improved charging and thermal conditioning efficiency (e.g., shorter charging time and less power consumed) and potential increased component life and decreased warranty costs.

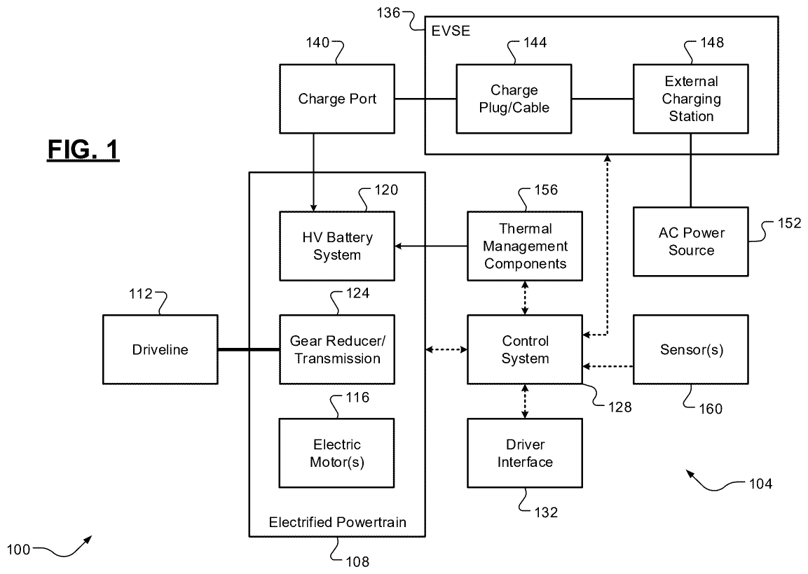

Referring now to FIG. 1, a functional block diagram of an electrified vehicle 100 having an example adaptive charging thermal optimization system 104 according to the principles of the present application is illustrated. The electrified vehicle 100 could be any type of plug-in chargeable electrified vehicle, such as a plug-in BEV or PHEV, as well as a fuel cell electrified vehicle (FCEV) having a plug-in chargeable high voltage battery pack or system. The electrified vehicle 100 includes an electrified powertrain 108 configured to generate and transfer drive torque to a driveline 112 for vehicle propulsion. The electrified powertrain 108 includes one or more electric motors 116 configured to generate drive torque using electrical energy provided by a high voltage battery pack or system 120 (e.g., comprising a plurality of battery cells). In some implementations, such as a PHEV configuration of the electrified vehicle 100, the electrified powertrain 108 also comprises an internal combustion engine (not shown) configured to combust a fuel/air mixture to generate drive torque, which is used for vehicle propulsion and/or for conversion to electrical energy (e.g., via a motor/generator unit) to recharge the high voltage battery system 120. The drive torque generated by the electric motor(s) 116 (and, in some implementations, the engine) is transferred to the driveline 112 via a transmission or gear reducer 124.

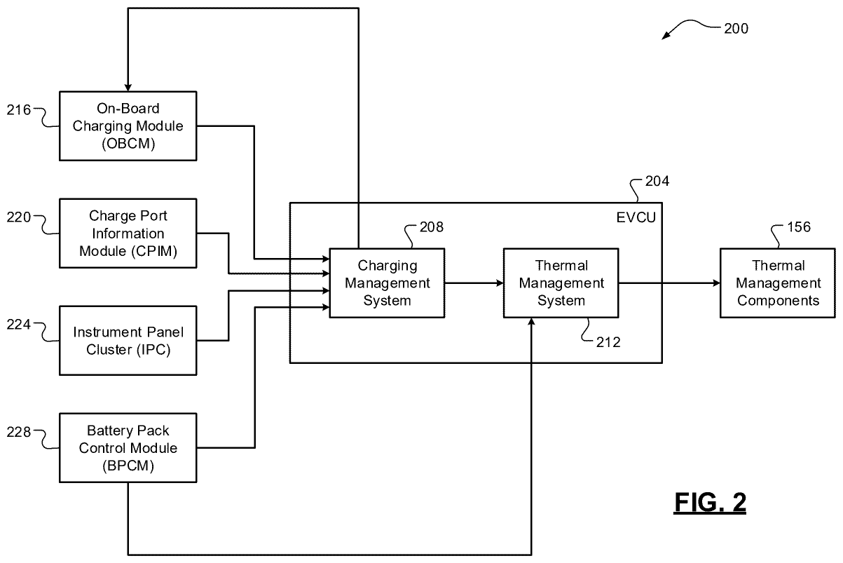

A controller or control system 128 is configured to control operation of the electrified vehicle 100. This primarily includes controlling the electrified powertrain 108 to generate a desired amount of drive torque to satisfy a driver torque request provided by a driver via a driver interface 132 (e.g., an accelerator pedal). The control system 128 could also include a plurality of sub-controllers or control modules, which will be described in greater detail below and illustrated in FIG. 2. The electrified vehicle 100 also includes a charge port 140 configured to be plugged into EVSE 136 for recharging the high voltage battery system 120 (e.g., via an on-board charging module OBCM 216; see FIG. 2). The EVSE 136 includes, for example, a charge plug/cable 144 and an external charging station 148 connected to an AC power source 152 (e.g., wall/line power).

In connection with charging, the electrified vehicle 100 also includes a set of thermal management components 156 (heating devices and/or cooling devices) for thermal management or conditioning of the high voltage battery system 120. These can include both low voltage components (fans, pumps, etc.) and high voltage components (electric coolant heaters, electric air compressors, etc.). The electrified vehicle 100 also includes a set of sensors 160 configured to measure desired operating parameters of the electrified vehicle 100, such as component speeds, temperatures, pressures, and the like.

Referring now to FIG. 2, a functional block diagram of an example system architecture 200 for the adaptive charging thermal optimization system 104 (e.g., the control system 128) according to the principles of the present application is illustrated. As shown, the system architecture 200 (also “system 200”) comprises an electrified vehicle control unit (EVCU) 204 that is configured as a primary or main controller or control module of the electrified vehicle 100. The EVCU 204 further comprises a charging management system 208 and a thermal management system 212. The charging management system is configured to provide various charging parameters and limits to the thermal management system 212, which in turn controls the thermal management components 156 accordingly. The charging management system 208 receives these inputs/limits from, for example, the OBCM 216, a charge plug information module (CPIM, 220), an instrument panel cluster (IPC, 224), and a battery pack control module (BPCM 228). The CPIM 220 is a vehicle-side module on where the physical charger plug 144 connects to the electrified vehicle 100. The IPC 224 could be, for example, part of the driver interface 132. The BPCM 228 could be, for example, as separate module that is part of or integrated with the high voltage battery system 120. The specific inputs/limits communicated in the system 200 will now be described in greater detail.

The OBCM 216 could provide, for example, a maximum current available and a voltage of the EVSE 136, an input current available, and a DC current available. The CPIM 220 could provide, for example, a CPIM temperature, light emitting diode (LED) light status, and/or a charge port lock function. The IPC 224 could provide, for example, a power level selection (e.g., by the driver). The BPCM 228 could provide, for example, a minimum battery temperature, a maximum battery temperature, a maximum current allowed, a battery cell voltage, and a state of charge (SOC) of the high voltage battery system 120. The BPCM 120 could also provide, for example, a minimum temperature, a maximum temperature, and a battery temperature health (SOH) target for the high voltage battery system 120 to the thermal management system 212. Based on the received inputs/limits, the charging management system 208 controls charging of the high voltage battery system 120 via the OBCM 216 and EVSE 136. The charging management system 208 also provides inputs/limits to the thermal management system 212, for example, a maximum target current, an operating mode/level, and a thermal power budget of the EVSE 136. Based on the received inputs/limits, as mentioned above, the thermal management system 212 controls the set of thermal management components 156 to thermally manage/condition the high voltage battery system 120 during the charging process.

The thermal management system 212 could provide, for example, a rationalized battery temperature target, a rationalized battery heating (BH) power, a rationalized battery cooling (BC) power, rationalized pump speeds, and a rationalized radiator fan speed. By having an adaptive thermal target that considers the charging current that the high voltage battery system 120 can accept based on its temperature and voltage, and the current available from the EVSE 136 or current limitations, the thermal management system 212 can target a temperature to condition the high voltage battery system 120 so that the electrified vehicle 100 will not waste time or energy and reduce unnecessary use of and extend the life of the thermal management components 156. The thermal management system 212 will be able to optimize the performance of the thermal management components 156 by optimizing battery conditioning rates through monitoring of the current available and adjusting its temperature target. The thermal management system 212 can stop conditioning the high voltage battery system 120 when the calculated thermal limit matches the calculated battery temperature threshold (which is determined by the max current available from the EVSE 136 and the current allowed for the high voltage battery system 120) or the life targets of the high voltage battery system 120.

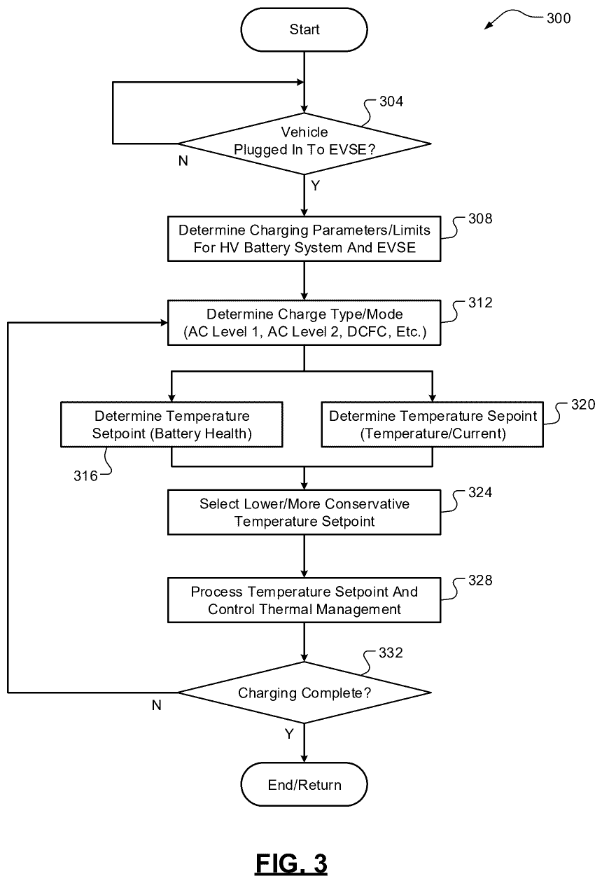

Referring now to FIG. 3, a flow diagram of an example adaptive charging thermal optimization method 300 for an electrified vehicle according to the principles of the present application is illustrated. While the method 300 specifically references the electrified vehicle 100 and its components for descriptive/illustrative purposes, it will be appreciated that the method 300 could be applicable to any suitably configured electrified vehicle capable of charging (e.g., plug-in charging) via EVSE. The method 300 begins at 304 where the control system 128 determines whether the electrified vehicle 100 is plugged into the EVSE 136 and whether any other relevant preconditions are satisfied. These precondition(s) could include, for example only, the electrified vehicle 100 there being no malfunctions or faults present that would negatively impact or otherwise inhibit the operation of the techniques of the present application. When false, the method 300 ends or returns to 304. When true, the method 300 proceeds to 308. At 308, the control system 128 determines a set of charging parameters and limits. In one exemplary implementation, these include (1) battery maximum temperature, (2) battery minimum temperature, (3) ambient temperature, (4) EVSE maximum current, (5) EVCU arbitrated current, (6) battery maximum allowable current.

At 312, the control system 128 determines the EVSE type or mode. For example, in North America, this could be defined by the SAW J1772Standard as one of (i) AC level one charging (e.g., ˜1.0 to 1.4 KW), (ii) AC level two charging (e.g., up to ˜19.2kW), and (iii) DCFC (e.g., ˜25-350 KW). As previously discussed, there could be different numbers and/or different types (AC vs. DC, power ranges, etc.) of types/modes/levels in North America as well as in other regions (LATAM, EMEA, APAC, etc.). For example, in the European Union (EU), this could be defined by the International Electrotechnical Commission (IEC) 61851-1 Standard as one of (i) Mode 2 charging, (ii) Mode 3 charging, and (iii) Mode 4 charging. At parallel 316 and 320, the control system 128 determines, based on all of these collected parameters/limits, (i) a target battery temperature setpoint for battery life (e.g., SOH limits) and (ii) a target battery temperature setpoint based on the temperature and input current. While shown in parallel, it will be appreciated that these operations 316-320 could be performed sequentially. At 324, the control system 128 selects the more conservative (i.e., lesser) of the two target battery temperature setpoints from 316 and 320. At 328, the control system 128 processes the selected battery temperature setpoint (e.g., by the thermal management system 212) to control the thermal management components 216 based on the EVSE and battery system current inputs. At 332, the control system 128 determines whether the charging procedure is complete. When true, the method 300 ends or returns to 304. When false, the method 300 returns to 316/320 (i.e., after 312).

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An adaptive charging thermal optimization system for an electrified vehicle, the adaptive charging thermal optimization system comprising:
a set of thermal management components each configured to thermally condition a high voltage battery system of the electrified vehicle; and
a control system configured to detect whether the electrified vehicle is plugged into electrified vehicle supply equipment (EVSE) and, in response to detecting that the electrified vehicle is plugged into the EVSE:
determine a set of charging parameters and limits for the high voltage battery system and the EVSE;
determine a type or mode of the EVSE;
determine a temperature setpoint for the high voltage battery system based on the charging parameters and limits for the high voltage battery system and the EVSE and the type or mode of the EVSE; and
control the set of thermal management components based on the determined temperature setpoint and a measured temperature of the high voltage battery system.

2. The adaptive charging thermal optimization system of claim 1, wherein the control system is configured to dynamically determine the temperature setpoint for the high voltage battery system.

3. The adaptive charging thermal optimization system of claim 2, wherein the determined temperature setpoint is not a predefined or predetermined temperature setpoint corresponding to the type or mode of the EVSE.

4. The adaptive charging thermal optimization system of claim 1, wherein the control system is further configured to:
determine a first temperature setpoint for the high voltage battery system based on a health or life target for the high voltage battery system;
determine a second temperature setpoint for the high voltage battery system based on temperature and input current to the high voltage battery system; and
select a lesser of the first and second temperature setpoints as the determined temperature setpoint for the high voltage battery system.

5. The adaptive charging thermal optimization system of claim 1, wherein the set of charging parameters and limits for the high voltage battery system and the EVSE include at least one of (i) battery maximum temperature, (ii) battery minimum temperature, (iii) ambient temperature, (iv) EVSE maximum current, (v) control system arbitrated current, and (vi) battery maximum allowable current.

6. The adaptive charging thermal optimization system of claim 1, wherein the set of charging parameters and limits for the high voltage battery system and the EVSE include (i) battery maximum temperature, (ii) battery minimum temperature, (iii) ambient temperature, (iv) EVSE maximum current, (v) control system arbitrated current, and (vi) battery maximum allowable current.

7. The adaptive charging thermal optimization system of claim 6, wherein the set of charging parameters and limits further includes at least one of (i) available input current, (ii) available DC current, (iii) driver power level selection, (iv) battery cell voltage, and (v) battery state of charge (SOC).

8. The adaptive charging thermal optimization system of claim 6, wherein the set of charging parameters and limits further includes (i) available input current, (ii) available DC current, (iii) driver power level selection, (iv) battery cell voltage, and (v) battery state of charge (SOC).

9. The adaptive charging thermal optimization system of claim 1, wherein the type or mode of the EVSE is defined by the Society of Automotive Engineers (SAE) J1772 Standard and is one of (i) AC level one charging, (ii) AC level two charging, and (iii) DC charging.

10. The adaptive charging thermal optimization system of claim 1, wherein the type or mode of the EVSE is defined by the International Electrotechnical Commission (IEC) 61851-1 Standard and is one of (i) Mode 2 charging, (ii) Mode 3 charging, and (iii) Mode 4 charging.

11. An adaptive charging thermal optimization method for an electrified vehicle, the adaptive charging thermal optimization method comprising:
detecting, by a control system of the electrified vehicle, whether the electrified vehicle is plugged into electrified vehicle supply equipment (EVSE); and
in response to detecting that the electrified vehicle is plugged into the EVSE:
determining, by the control system, a set of charging parameters and limits for the high voltage battery system and the EVSE;
determining, by the control system, a type or mode of the EVSE;
determining, by the control system, a temperature setpoint for the high voltage battery system based on the charging parameters and limits for the high voltage battery system and the EVSE and the type or mode of the EVSE; and
based on the determined temperature setpoint and a measured temperature of the high voltage battery system, controlling, by the control system, a set of thermal management components each configured to thermally condition a high voltage battery system of the electrified vehicle.

12. The adaptive charging thermal optimization method of claim 11, wherein the determining of the temperature setpoint is performed dynamically based on based on the charging parameters and limits for the high voltage battery system and the EVSE and the type or mode of the EVSE.

13. The adaptive charging thermal optimization method of claim 12, wherein the determined temperature setpoint is not a predefined or predetermined temperature setpoint corresponding to the type or mode of the EVSE.

14. The adaptive charging thermal optimization method of claim 11, further comprising:
determining, by the control system, a first temperature setpoint for the high voltage battery system based on a health or life target for the high voltage battery system;
determining, by the control system, a second temperature setpoint for the high voltage battery system based on temperature and input current to the high voltage battery system; and
selecting, by the control system, a lesser of the first and second temperature setpoints as the determined temperature setpoint for the high voltage battery system.

15. The adaptive charging thermal optimization method of claim 11, wherein the set of charging parameters and limits for the high voltage battery system and the EVSE include at least one of (i) battery maximum temperature, (ii) battery minimum temperature, (iii) ambient temperature, (iv) EVSE maximum current, (v) control system arbitrated current, and (vi) battery maximum allowable current.

16. The adaptive charging thermal optimization method of claim 11, wherein the set of charging parameters and limits for the high voltage battery system and the EVSE include (i) battery maximum temperature, (ii) battery minimum temperature, (iii) ambient temperature, (iv) EVSE maximum current, (v) control system arbitrated current, and (vi) battery maximum allowable current.

17. The adaptive charging thermal optimization method of claim 16, wherein the set of charging parameters and limits further includes at least one of (i) available input current, (ii) available DC current, (iii) driver power level selection, (iv) battery cell voltage, and (v) battery state of charge (SOC).

18. The adaptive charging thermal optimization method of claim 16, wherein the set of charging parameters and limits further includes (i) available input current, (ii) available DC current, (iii) driver power level selection, (iv) battery cell voltage, and (v) battery state of charge (SOC).

19. The adaptive charging thermal optimization method of claim 11, wherein the type or mode of the EVSE is defined by the Society of Automotive Engineers (SAE) J1772 Standard and is one of (i) AC level one charging, (ii) AC level two charging, and (iii) DC charging.

20. The adaptive charging thermal optimization method of claim 11, wherein the type or mode of the EVSE is defined by the International Electrotechnical Commission (IEC) 61851-1 Standard and is one of (i) Mode 2 charging, (ii) Mode 3 charging, and (iii) Mode 4 charging.
